(19) United States
(12) Patent Application Publication
(10) Pub. No.: US 2021/0077356 A1
(43) Pub. Date: Mar. 18, 2021

(54) Fluid Heating Device

(71) Applicant: Brannen Cunningham, Waynesville, NC (US)

(72) Inventor: Brannen Cunningham, Waynesville, NC (US)

(21) Appl. No.: 16/573,256

(22) Filed: Sep. 17, 2019

(51) Int. Cl. A61J 15/00

(52) U.S. Cl. CPC A61J 15/0003; A61J 2200/72; A61J 2200/42; A61J 15/0092

(57) ABSTRACT

A fluid heating device for on demand heating of fluids for feeding a child includes a pipe that is coupled to and extends from a control module, which comprises a power module. A first and a second tube are coupled to and extend from a first and a second end of the pipe, respectively. A terminus of the first tube is positionable in a reservoir that contains a fluid. A nipple that is coupled to the second tube distal from the pipe is configured to be positioned in a mouth of a child, positioning the child to suck on the nipple to draw the fluid from the reservoir through the first tube into the pipe. A heating element in the pipe heats the fluid as it passes through the pipe. The fluid then passes through the second tube and a hole in the nipple into the mouth of the child.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relate to heating devices and more particularly pertains to a new heating device for on demand heating of fluids for feeding a child.

### BRIEF SUMMARY OF THE INVENTION

An embodiment of the disclosure meets the needs presented above by generally comprising a pipe that is coupled to and extends from a control module, which comprises a power module. A first and a second tube are coupled to and extend from a first and a second end of the pipe, respectively. A terminus of the first tube is positionable in a reservoir that contains a fluid. A nipple that is coupled to the second tube distal from the pipe is configured to be positioned in a mouth of a child, positioning the child to suck on the nipple to draw the fluid from the reservoir through the first tube into the pipe. A heating element in the pipe heats the fluid as it passes through the pipe. The fluid then passes through the second tube and a hole in the nipple into the mouth of the child.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a fluid heating device according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure.

FIG. 5 is a block diagram of an embodiment of the disclosure.

### DETAILED DESCRIPTION OF THE INVENTION

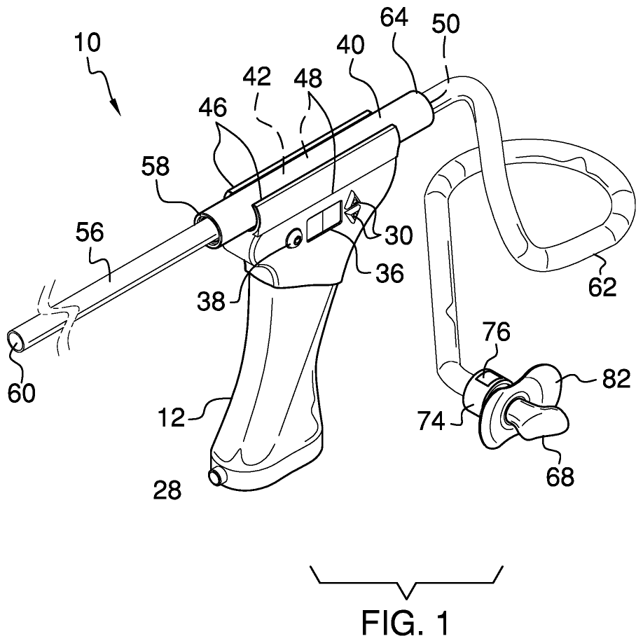

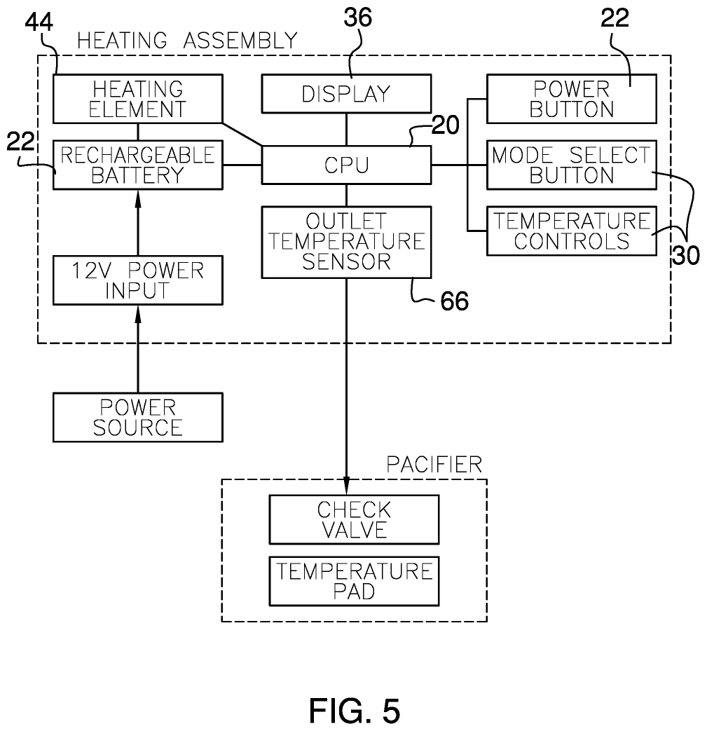

With reference now to the drawings, and in particular to FIGS. 1 through 5 thereof, a new heating device embodying the principles and concepts of an embodiment of the disclosure and generally designated by the reference numeral 10 will be described.

As best illustrated in FIGS. 1 through 5, the fluid heating device 10 generally comprises a control module 12 that is configured to be grasped in a hand of a user. The control module 12 comprises a housing 14 that defines an interior space 16. The housing 14 is pistol grip shaped so that the housing 14 is configured to be grasped in the hand of the user. A power module 18 and a microprocessor 20 are coupled to the housing 14 and are positioned in the interior space 16. The microprocessor 20 is operationally coupled to the power module 18.

The power module 18 comprises a battery 22, which is rechargeable. A slot 24 that extends into a base 26 of the housing 14 is complementary to the battery 22 so that the battery 22 is selectively positionable in the slot 24 to removably couple the battery 22 to the housing 14. A port 28 that is positioned in the housing 14 proximate to the base 26 is operationally coupled to the power module 18. The port 28 is selectively couplable to a cord that is coupled to a source of alternating current to recharge the battery 22.

A control panel 30 is coupled to the housing 14 and is operationally coupled to the microprocessor 20. The control panel 30 is configured for input a temperature setpoint into the microprocessor 20. The control panel 30 comprises a first button 32 and a second button 34, which are depressible. The first button 32 is configured to be depressed to increase the temperature setpoint. The second button 34 is configured to be depressed to decrease the temperature setpoint.

A display 36 and a power button 38 are coupled to the housing 14 and are operationally coupled to the microprocessor 20. The microprocessor 20 is positioned to signal the display 36 to selectively present the temperature setpoint and a temperature reading to the user. The power button 38 is configured to be depressed a first time to signal the microprocessor 20 to power up the control module 12 and to be depressed a second time to depower the control module 12.

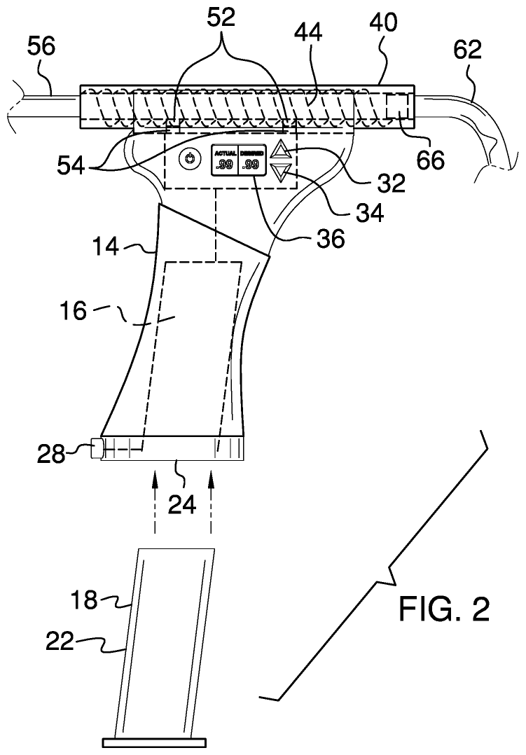

A pipe 40 is coupled to and extends bidirectionally from an upper face 42 of the control module 12. A heating element 44 is coiledly embedded in the pipe 40, as shown in FIG. 2. The pipe 40 comprises stainless steel. Each of a pair of plates 46 is coupled to and extends arcuately from a respective opposing edge 48 of the upper face 42 of the control module 12 so that the pair of plates 46 defines a channel 50. The channel 50 is substantially complementary to the pipe 40 so that the channel 50 is positioned to insert the pipe 40 to removably couple the pipe 40 to the control module 12.

A pair of first contacts 52 is coupled to the pipe 40. The first contacts 52 are operationally coupled to the heating element 44. A pair of second contacts 54 is coupled to the upper face 42 of the control module 12. The second contacts 54 are operationally coupled the power module 18 so that each second contact 54 is positioned to contact a respective first contact 52, as the pipe 40 is inserted into the channel 50, to electrically couple the heating element 44 to the power module 18.

A first tube 56 is coupled to and extends from a first end 58 of the pipe 40 so that the first tube 56 is fluidically coupled to the pipe 40. A terminus 60 of the first tube 56 that is distal from the pipe 40 is configured to be positioned in a reservoir that contains a fluid, such a breast milk, baby formula, or the like.

A second tube 62 is coupled and extends from a second end 64 of the pipe 40 so that the second tube 62 is fluidically coupled to the pipe 40. The heating element 44 is configured to heat the fluid as it passes through the pipe 40. The second tube 62 and the first tube 56 are removably couplable to the pipe 40 so that the second tube 62 and the first tube 56 are configured to be cleaned separately from the pipe 40. The second tube 62 and the first tube 56 comprise silicone so that the second tube 62 and the first tube 56 are configured to be positioned in at least one of boiling water and a dishwasher to clean and sterilize the second tube 62 and the first tube 56.

A temperature probe 66 is coupled to the pipe 40 proximate to the second end 64, as shown in FIG. 2. The temperature probe 66 is configured to obtain the temperature reading of the fluid that flows from the pipe 40 into the second tube 62 and to communicate the temperature reading to the microprocessor 20. The microprocessor 20 is positioned to adjust an output of the heating element 44, as required, to match the temperature reading to the temperature setpoint. The microprocessor 20 also is positioned to signal the display 36 to present the temperature reading to the user.

A nipple 68 is coupled to the second tube 62 distal from the pipe 40. The nipple 68 is configured to be positioned in a mouth of a child, positioning the child to suck on the nipple 68 so that the fluid is suctionally drawn from the reservoir through the first tube 56 into the pipe 40. The heating element 44 is configured to heat the fluid as it passes through the pipe 40 to the second tube 62. The fluid passes through the second tube 62 and a hole 70 in the nipple 68 into the mouth of the child. The nipple 68 comprises at least one of rubber, silicone, and plastic.

One advantage of the device 10 is that only the quantity of fluid that passes through the pipe 40 is actually heated. When the child is done feeding, the fluid remaining in the reservoir can be placed back in a cooling environment, such as a refrigerator, cooler, or the like, to preserve the fluid and to prevent waste.

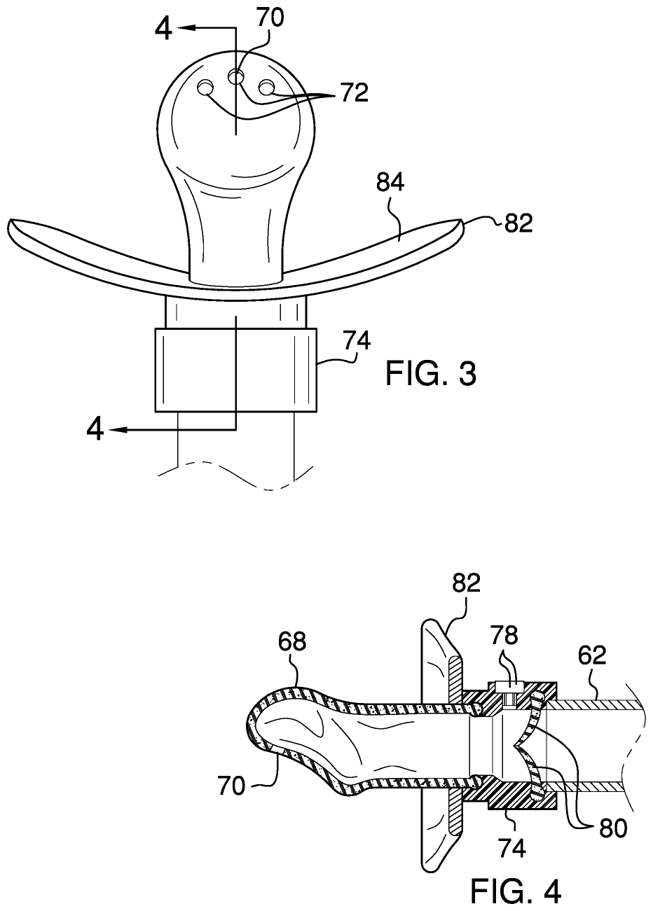

The hole 70 in the nipple 68 comprises a plurality of orifices 72 so that the plurality of orifices 72 mimics a plurality of milk duct orifices of a mammary papilla. The plurality of orifices 72 comprises from two to twenty orifices 72. The plurality of orifices 72 comprises three orifices 72, as shown in FIG. 3.

A third tube 74 is coupled to the nipple 68 distal from the hole 70 so that the third tube 74 is positioned to insert the second tube 62 to removably couple the second tube 62 to the nipple 68, as shown in FIG. 4. A thermometer 76 is coupled to the third tube 74, as shown in FIG. 1. The thermometer 76 comprises a plurality of thermochromatic compounds 78. Each thermochromatic compound 78 has a respective color at an associated temperature so that the plurality of thermochromatic compounds 78 comprises thermochromatic compounds 78 that have a variety of respective colors, each at an associated temperature. The thermometer 76 is configured to display a respective color that represents an associated temperature of the fluid as it enters the nipple 68.

A valve 80 is coupled to and is positioned in the third tube 74, as shown in FIG. 4. The valve 80 is non-return type so that the valve 80 is configured to prevent flow of the fluid from the nipple 68 back into the second tube 62.

A panel 82 is coupled to the third tube 74 proximate to the nipple 68, as shown in FIG. 3. The panel 82 is arcuate so that the panel 82 has a concave face 84 that extends toward the nipple 68. The concave face 84 is substantially complementary to a curvature of a mouth region of the child. The panel 82 comprises at least one of rubber, silicone, and plastic.

In use, the terminus 60 of the first tube 56 is positioned in the reservoir that contains the fluid, such the breast milk. The first button 32 and the second button 34 used to adjust the temperature setpoint as desired. The nipple 68 is positioned in the mouth of the child, positioning the child to suck on the nipple 68 so that the fluid is suctionally drawn from the reservoir through the first tube 56 into the pipe 40. The heating element 44 warms the fluid as it passes through the pipe 40 to the second tube 62. The fluid passes through the second tube 62 and the hole 70 in the nipple 68 into the mouth of the child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid heating device comprising:
a control module configured for grasping in a hand of a user, the control module comprising a power module;
a pipe coupled to and extending bidirectionally from an upper face of the control module;
a heating element coiledly embedded in the pipe;
a first tube coupled to and extending from a first end of the pipe such that the first tube is fluidically coupled to the pipe wherein a terminus of the first tube distal from the pipe is configured for positioning in a reservoir containing a fluid;
a second tube coupled and extending from a second end of the pipe such that the second tube is fluidically coupled to the pipe wherein the heating element is configured for heating the fluid as it passes through the pipe; and
a nipple coupled to the second tube distal from the pipe wherein the nipple is configured for positioning in a mouth of a child positioning the child for sucking on the nipple such that the fluid is suctionally drawn from the reservoir through the first tube into the pipe, wherein the heating element is configured for heating the fluid, and then through the second tube and a hole in the nipple into the mouth of the child.

2. The device of claim 1, further including the control module comprising:
a housing defining an interior space, the housing being pistol grip shaped wherein the housing is configured for grasping in the hand of the user, the power module being coupled to the housing and positioned in the interior space;
a microprocessor coupled to the housing and positioned in the interior space, the microprocessor being operationally coupled to the power module;
a control panel coupled to the housing, the control panel being operationally coupled to the microprocessor wherein the control panel is configured for inputting a temperature setpoint into the microprocessor;
a display coupled to the housing, the display being operationally coupled to the microprocessor such that the microprocessor is positioned for signaling the display for selectively presenting the temperature setpoint and a temperature reading to the user; and
a power button coupled to the housing, the power button being operationally coupled to the microprocessor, the power button being depressible wherein the power button is configured for depressing a first time for signaling the microprocessor for powering up the control module and for depressing a second time for depowering the control module.

3. The device of claim 2, further comprising:
the power module comprising a battery, the battery being rechargeable; and
a port positioned in the housing proximate to the base, the port being operationally coupled to the power module, the port being selectively couplable to a cord coupled to a source of alternating current for recharging the battery.

4. The device of claim 3, further including a slot extending into a base of the housing, the slot being complementary to the battery such that the battery is selectively positionable in the slot for removably coupling the battery to the housing.

5. The device of claim 2, further including the control panel comprising a first button and a second button, the first button and the second button being depressible wherein the first button is configured for depressing for increasing the temperature setpoint and wherein the second button is configured for depressing for decreasing the temperature setpoint.

6. The device of claim 1, further including the second tube and the first tube being removably couplable to the pipe such that the second tube and the first tube are configured for being cleaned separately from the pipe.

7. The device of claim 6, further including the second tube and the first tube comprising silicone wherein the second tube and the first tube are configured for being positioned in at least one of boiling water and a dishwasher.

8. The device of claim 1, further comprising:
a pair of plates, each plate being coupled to and extending arcuately from a respective opposing edge of the upper face of the control module such that the pair of plates defines a channel, the channel being substantially complementary to the pipe such that the channel is positioned for inserting the pipe for removably coupling the pipe to the control module;
a pair of first contacts coupled to the pipe, the first contacts being operationally coupled to the heating element; and
a pair of second contacts coupled to the upper face of the control module, the second contacts being operationally coupled the power module such that each second contact is positioned for contacting a respective first contact as the pipe is inserted into the channel for electrically coupling the heating element to the power module.

9. The device of claim 1, further including the pipe comprising stainless steel.

10. The device of claim 2, further including a temperature probe coupled to the pipe proximate to the second end wherein the temperature probe is configured for obtaining the temperature reading of the fluid flowing from the pipe into the second tube and for communicating the temperature reading to the microprocessor positioning the microprocessor for adjusting an output of the heating element, as required, to match the temperature reading to the temperature setpoint, and such that the microprocessor is positioned for signaling the display for presenting the temperature reading to the user.

11. The device of claim 1, further including the nipple comprising at least one of rubber, silicone, and plastic.

12. The device of claim 1, further including the hole comprising a plurality of orifices such that the plurality of orifices mimics a plurality of milk duct orifices of a mammary papilla.

13. The device of claim 12, further including the plurality of orifices comprising from two to twenty orifices.

14. The device of claim 13, further including the plurality of orifices comprising three orifices.

15. The device of claim 1, further including a third tube coupled to the nipple distal from the hole such that the third tube is positioned for inserting the second tube for removably coupling the second tube to the nipple.

16. The device of claim 15, further including a thermometer coupled to the third tube, the thermometer comprising a plurality of thermochromatic compounds, each thermochromatic compound having a respective color at an associated temperature such that the plurality of thermochromatic compounds comprises thermochromatic compounds that have a variety of respective colors, each at an associated temperature wherein the thermometer is configured for displaying a respective color representing an associated temperature of the fluid as it enters the nipple.

17. The device of claim 15, further including a valve coupled to and positioned in the third tube, the valve being non-return type wherein the valve is configured for preventing flow of the fluid from the nipple back into the second tube.

18. The device of claim 15, further including a panel coupled to the third tube proximate to the nipple, the panel being arcuate such that the panel has a concave face extending toward the nipple, the concave face being substantially complementary to a curvature of a mouth region of the child.

19. The device of claim 18, further including the panel comprising at least one of rubber, silicone, and plastic.

20. A fluid heating device comprising:
a control module configured for grasping in a hand of a user, the control module comprising a power module, the control module comprising:
a housing defining an interior space, the housing being pistol grip shaped wherein the housing is configured for grasping in the hand of the user, the power module being coupled to the housing and positioned in the interior space, the power module comprising a battery, the battery being rechargeable,
a slot extending into a base of the housing, the slot being complementary to the battery such that the battery is selectively positionable in the slot for removably coupling the battery to the housing,
a port positioned in the housing proximate to the base, the port being operationally coupled to the power module, the port being selectively couplable to a cord coupled to a source of alternating current for recharging the battery,
a microprocessor coupled to the housing and positioned in the interior space, the microprocessor being operationally coupled to the power module,
a control panel coupled to the housing, the control panel being operationally coupled to the microprocessor wherein the control panel is configured for inputting a temperature setpoint into the microprocessor, the control panel comprising a first button and a second button, the first button and the second button being depressible wherein the first button is configured for depressing for increasing the temperature setpoint and wherein the second button is configured for depressing for decreasing the temperature setpoint,
a display coupled to the housing, the display being operationally coupled to the microprocessor such that the microprocessor is positioned for signaling the display for selectively presenting the temperature setpoint and a temperature reading to the user, and
a power button coupled to the housing, the power button being operationally coupled to the microprocessor, the power button being depressible wherein the power button is configured for depressing a first time for signaling the microprocessor for powering up the control module and for depressing a second time for depowering the control module;
a pipe coupled to and extending bidirectionally from an upper face of the control module, the pipe comprising stainless steel;
a pair of plates, each plate being coupled to and extending arcuately from a respective opposing edge of the upper face of the control module such that the pair of plates defines a channel, the channel being substantially complementary to the pipe such that the channel is positioned for inserting the pipe for removably coupling the pipe to the control module;
a heating element coiledly embedded in the pipe;
a pair of first contacts coupled to the pipe, the first contacts being operationally coupled to the heating element;
a pair of second contacts coupled to the upper face of the control module, the second contacts being operationally coupled the power module such that each second contact is positioned for contacting a respective first contact as the pipe is inserted into the channel for electrically coupling the heating element to the power module;
a first tube coupled to and extending from a first end of the pipe such that the first tube is fluidically coupled to the pipe wherein a terminus of the first tube distal from the pipe is configured for positioning in a reservoir containing a fluid;
a second tube coupled and extending from a second end of the pipe such that the second tube is fluidically coupled to the pipe wherein the heating element is configured for heating the fluid as it passes through the pipe, the second tube and the first tube being removably couplable to the pipe such that the second tube and the first tube are configured for being cleaned separately from the pipe, the second tube and the first tube comprising silicone wherein the second tube and the first tube are configured for being positioned in at least one of boiling water and a dishwasher;
a temperature probe coupled to the pipe proximate to the second end wherein the temperature probe is configured for obtaining the temperature reading of the fluid flowing from the pipe into the second tube and for communicating the temperature reading to the microprocessor positioning the microprocessor for adjusting an output of the heating element, as required, to match the temperature reading to the temperature setpoint, and such that the microprocessor is positioned for signaling the display for presenting the temperature reading to the user;
a nipple coupled to the second tube distal from the pipe wherein the nipple is configured for positioning in a mouth of a child positioning the child for sucking on the nipple such that the fluid is suctionally drawn from the reservoir through the first tube into the pipe, wherein the heating element is configured for heating the fluid, and then through the second tube and a hole in the nipple into the mouth of the child, the nipple comprising at least one of rubber, silicone, and plastic, the hole comprising a plurality of orifices such that the plurality of orifices mimics a plurality of milk duct orifices of a mammary papilla, the plurality of orifices comprising from two to twenty orifices, the plurality of orifices comprising three orifices;
a third tube coupled to the nipple distal from the hole such that the third tube is positioned for inserting the second tube for removably coupling the second tube to the nipple;
a thermometer coupled to the third tube, the thermometer comprising a plurality of thermochromatic compounds, each thermochromatic compound having a respective color at an associated temperature such that the plurality of thermochromatic compounds comprises thermochromatic compounds that have a variety of respective colors, each at an associated temperature wherein the thermometer is configured for displaying a respective color representing an associated temperature of the fluid as it enters the nipple;
a valve coupled to and positioned in the third tube, the valve being non-return type wherein the valve is configured for preventing flow of the fluid from the nipple back into the second tube; and
a panel coupled to the third tube proximate to the nipple, the panel being arcuate such that the panel has a concave face extending toward the nipple, the concave face being substantially complementary to a curvature of a mouth region of the child, the panel comprising at least one of rubber, silicone, and plastic.
